(19) United States
(12) Patent Application Publication
(10) Pub. No.: US 2023/0175786 A1
(43) Pub. Date: Jun. 8, 2023

(54) EXCHANGER DEVICE

(71) Applicant: VIESSMANN CLIMATE SOLUTIONS SE, Allendorf (Eder) (DE)

(72) Inventors: Jörg EVERTZ, Birmensdorf (CH); Dominik EGGERT, Zürich (CH); Uwe WERNER, Hutten (CH)

(73) Assignee: VIESSMANN CLIMATE SOLUTIONS SE, Allendorf (Eder) (DE)

(21) Appl. No.: 17/913,028

(22) PCT Filed: Mar. 16, 2021
(86) PCT No.: PCT/EP2021/056674

§ 371 Date: Sep. 20, 2022

(30) Foreign Application Priority Data
Mar. 20, 2020 (EP) 20164725.2

(51) Int. Cl. F28D 9/04; F28D 21/00

(52) U.S. Cl. CPC F28D 9/04; F28D 21/0015; F28F 21/00

(57) ABSTRACT

The invention relates to an exchanger device comprising a first and a second end piece (1, 2) and an exchanger body (3, 4) arranged in-between. At least one first and one second channel (150, 151) in the exchanger body (3, 4) connect inlets and outlets (10, 11, 20, 21) of the two end pieces (1, 2), wherein the inlets and outlets (10, 11, 20, 21) are arranged in end faces of the end pieces (1, 2), which face away from the exchanger body. The exchanger body forms a multi-helix, in particular a double helix or multiple concentric ring surfaces, wherein the windings of the multi-helix or the concentric ring surfaces form separating walls (3, 4) between the at least one first and the at least one second channel (150, 151). The device according to the invention allows for the formation of exchanger devices with high efficiency yet also with a small outer diameter. The manufacturing process is also simplified.

### TECHNICAL FIELD

The present invention relates to an exchanger device, in particular a heat exchanger and/or a mass-transfer device, and to a method for producing such a device.

### PRIOR ART

Heat exchangers serve for transferring heat from one fluid to another fluid. Also, devices for transferring mass between fluids, so-called mass-transfer devices or filters, are known. Known heat exchangers or mass-transfer devices have flow channels through which the fluids flow and which are separated from one another by heat-permeable or heat-transferring and/or substance-permeable walls. Depending on application area, the fluids are guided in a uniflow configuration, counterflow configuration, crossflow configuration, cross-counterflow configuration, vortical-flow configuration or combinations thereof. Optimum efficiencies are achieved if the heat-exchange or mass-transfer surface area is as large as possible.

There is an increased use of heat exchangers in the area of building ventilation for the purpose of heat recovery. Decentralized ventilation systems are reliant on individual room fans with heat recovery. In these systems, each room has a heat exchanger which is normally attached in the building outer wall and which leads directly from the building interior to the outside. Exchange of air is realized by means of fans attached to or in the heat exchanger. There are units with continuous operation and push/pull fans in the case of which, in an alternating manner, inside air is conveyed to the outside and outside air is transported to the inside.

EP 2 379 978 B1 discloses a heat exchanger with in each case one fluid distributor at each end, these having two concentric first access points on one side and second access points in the form of circular sectors on the opposite side. The transition from the first access points into the second access points is realized via incisions and protuberances with sinusoidal trajectories.

WO 2016/096965 A1 presents a heat exchanger with multiple flow zones, wherein the middle zone has circular sector-shaped channels. WO 2019/017831 A1 uses circular sector-shaped channels too.

DE 20 2010008 955 U1 relates to a counterflow heat exchanger having two end caps for introduction into the corresponding channel of the fluid in each case flowing in from an end side. The main body of the heat exchanger has channels in the form of multiple circular sectors, or it is in the form of a single spiral or multiple spiral.

WO 2006/032258 A1 discloses a heat exchanger having a sheet-like material which is wound in a spiral-shaped manner. The windings of the spiral form the separating walls between the channels flowed through by the fluids. Separating webs between adjacent windings additionally separate the channels.

DE 36 27 578 A1 describes a heat exchanger for individual room ventilation in the form of a double spiral. Supply air and exhaust air are guided via the lateral surface. This design makes it impossible for the heat exchanger to be arranged in house walls.

Specifically in the case of individual room fans, but not only in this case, it is necessary for the exchanger device to be designed to be as small and compact as possible, in particular to have the smallest possible outer diameter. Nevertheless, the intention is for the exchanger device to have an efficiency which is as high as possible, and for the production thereof to be realized in as simple and inexpensive a manner as possible.

### SUMMARY OF THE INVENTION

It is therefore an object of the invention to provide an improved exchanger device which meets the aforementioned requirements.

Said object is achieved by an exchanger device having the features of claim 1, and by a method for producing such an exchanger device having the features of claim 16.

The exchanger according to the invention has a first end piece, a second end piece, and an exchanger body arranged therebetween. The first end piece has a first end side with a first inlet and with a first outlet, and the second end piece has a second end side with a second inlet and with a second outlet. The first and second end sides face away from the exchanger body. The exchanger body has at least one first channel which connects the first inlet of the first end piece to the second outlet of the second end piece. The exchanger body moreover has at least one second channel which connects the second inlet of the second end piece to the first outlet of the first end piece. According to the invention, the exchanger body forms a multiple spiral, in particular a double spiral, or multiple concentric ring surfaces, wherein the windings of the multiple spiral or of the concentric ring surfaces form separating walls between the at least one first and the at least one second channel.

In the language used here, a double spiral or multiple spiral is a structure which forms in cross-sectional planes a line wound around a center.

When using the exchanger device, an outlet may also be used as an inlet. The inlet of the oppositely situated end piece consequently becomes an outlet. The terms “inlet” and “outlet” in this text, in particular in the patent claims, are thus accordingly also to be understood as meaning “outlet” and “inlet”.

Owing to the configuration of the exchanger body, the exchange surface area for the heat exchange is maximized and the efficiency is optimized. The flow behavior of the fluids is optimized, so that vibrations and disturbing noises that occur as a result are avoided and the required power of the fan is minimized. The windings of the multiple spiral or of the concentric ring surfaces preferably extend in a concentric manner. The configuration of the exchanger body as concentric double spiral is preferred.

The device can be configured to be extremely compact and to have a small diameter. It can be used for example in a building-wall bore with a diameter of 160 mm.

The device according to the invention is suitable for example for use as a heat exchanger, in particular for individual room ventilation arrangements or in building-centralized ventilation units. However, with a suitable choice of the material of the exchanger body, said device may also be used for example as a mass-transfer device with a filter or transfer function. Combinations of heat exchanger and mass-transfer device are likewise possible with a suitable material of the exchanger body. Such materials are known. Preferably, the exchanger body is formed from a membrane or film. For example, materials having solely a heat-conduction function, such as for example aluminum, or else relatively complex membranes having heat-conduction and vapor-permeability properties, so-called enthalpy exchangers, can be used. Enthalpy exchangers serve for simultaneous heat recovery and air-moisture recovery and, in the case of domestic ventilation arrangements, prevent an indoor climate that is too dry.

Preferably, the device is used in counterflow operation. It can be used for example as a continuously operating individual room ventilation unit, in the case of which, simultaneously, an air stream flows into the building and out of the building and, by contrast to push/pull fans in push/pull operation, requires only one unit or one building-wall bore. Preferably, at one or at both end sides of the device, there are attached fans for conveying the air through the device. The fans can preferably be fastened in or on the end pieces.

The device according to the invention can be used not only for air flows but also for other fluid flows, in particular for gases or liquids, such as for example water, or for a mixture of gas, as first fluid, and a liquid, as second fluid.

Preferably, the exchanger body defines a longitudinal direction, wherein the end pieces are arranged on in each case one end-side end of the exchanger body, and wherein the at least one first and the at least one second channel can be flowed through in the longitudinal direction of the exchanger body. This arrangement can provide a large exchanger surface area with a low flow resistance or with a low pressure loss and thus achieves a high exchanger efficiency with low noise generation.

Preferably, both end pieces are configured as a fluid distributor and have a distribution structure for diverting the fluids. In this regard, it is preferably the case that the first end piece has a distribution structure for diverting a first fluid from the first inlet into the at least one first channel of the exchanger body. The second end piece has a distribution structure for diverting a second fluid from the second inlet into the at least one second channel of the exchanger body. Both end pieces have end sides which face away from the first-mentioned end sides thereof and which form a multiple spiral, in particular a double spiral, or concentric ring surfaces. Said multiple spiral or the concentric ring-surface structure is matched in terms of its shape, its number of windings and its cross section preferably to the shape and configuration of the multiple spiral or the concentric ring-surface structure of the exchanger body.

The two end pieces may be of identical or different form. The inlet and outlet of each end pieces may for example be arranged concentrically with respect to one another, form eccentric circular surfaces, or have the form of two adjacently arranged circular surfaces, semicircles or circle segments. Each end piece may also have two or more inlets and/or outlets.

The configuration of the two end pieces as fluid distributor with the end sides facing toward the exchanger body and in the form of a multiple spiral or in the form of concentric ring surfaces simplifies the production. The end pieces can be produced as separate components, for example from plastic in an injection-molding process or in a 3D printing process, and subsequently be connected to the exchanger body during the assembly of the device. The exchanger body can thus be offered in different lengths and/or with different (for example heat, moisture, mass) exchange/transfer properties. It is consequently possible for different devices to be manufactured using the same basic elements. This reduces the production costs.

The production is more facilitated if the multiple spiral or the concentric ring-surface structure formed on the end pieces projects outward toward its center, for example in that it is of conically outwardly projecting form.

The device can be produced in a particularly simple manner if the multiple spiral of the exchanger body is formed by at least two material webs which are wound up together. In the case of a double spiral, exactly two material webs are wound up in a concentric manner together. In preferred embodiments, the material webs are of self-supporting form. The material webs are of different form depending on embodiment. For example, they are clamped between the end pieces. In further embodiments, spacers are present between the windings of the material webs. The spacers, depending on embodiment, extend over the entire length of the exchanger body or are sectionally interrupted or are present merely at points. Preferably, they extend in the longitudinal direction of the device. The embodiments mentioned may also be combined with one another to form new variants.

Preferably, the walls of the multiple spiral, in particular the double spiral, extend at an equal distance from another over the entire length of the exchanger body. It is also possible, however, for the distances to vary in the cross section of the exchanger body and/or along its longitudinal direction. Preferably, the spiral has a substantially circular cross section. In other embodiments, however, the windings are such that the spiral has a triangular, quadrangular, square, hexagonal, octagonal or dodecagonal cross section. However, any other desired polygonal cross sections and even asymmetrical shapes may be used.

Depending on embodiment, the walls of the double spiral extend in a bent manner over all the windings. They may however also extend in a sectionally rectilinear or outwardly curved manner and be bent in the form of rounded or sharp edges.

The end pieces, too, may have corresponding cross-sectional shapes.

Non-round shapes facilitate stackability and thus storage of the device. Such stackable devices can, as a multiple device, also be used connected in series or parallel in installations. Round shapes facilitate use in building bores. Preferably, the device or at least the exchanger body has outer dimensions that remain the same over the entire length. In other embodiments, the outer dimensions vary, for example the outer diameter varies.

As already mentioned, different materials can be used for the exchanger body. Preferably, the multiple spiral or the concentric ring structure of the exchanger body is formed from at least one enthalpy-exchanger membrane. Said membrane forms an exchange/transfer surface.

In preferred embodiments, the exchanger body has an exchange/transfer surface for exchange of heat and/or transfer or mass, and the exchanger device has a passage opening which extends from the first end piece to the second end piece through the exchanger body and which runs separately from the exchange/transfer surface. This makes possible a fluid flow which is not subjected to heat exchange or mass transfer. Preferably, the device can be selectively operated in heat-exchange and/or mass-transfer mode or in bypass mode by way of the stated passage opening. The bypass mode is desirable for example if air drawn into the room at night during summer is not to be heated. This device facilitates cooling of the building.

The device can be produced in different ways. It may be formed in one piece or in multiple pieces and be produced for example in an injection-molding process or in a 3D printing process. If the exchanger body has material webs, then the method according to the invention mentioned below is particularly suitable.

In this method for producing the above-described exchanger device, the first end piece and the second end piece are arranged at a defined distance from one another. For forming the multiple spiral, in particular the double spiral, of the exchanger body, at least one first material web, from a first side, and at least one second material web, from a second side, are wound up together. The two end-side ends of the wound-up material webs are connected to the first and/or to the second end piece during or after the winding. In preferred variants of the method, a cover is arranged at least over the outer curved area of the material webs wound up to form the multiple spiral. In other variants of the method, at the end of the winding process, the material webs, without being spaced apart from one another, are preferably wound up multiple times. In this way, they form a termination, that is to say a closed lateral surface, which performs the function of a cover. It is advantageous in this variant if the material webs are self-supporting.

Here, the material webs are preferably membranes. If the end pieces have spiral structures which project toward the center, then the membrane preferably widens toward the outside. This facilitates the winding onto the end pieces. Preferably, already during the winding onto the end pieces, the material webs are connected, for example adhesively bonded or welded, thereto. The cover is for example a sleeve slipped over the exchanger body and, depending on embodiment, over the end pieces too. Preferably, the cover consists however of two semicylindrical shells which can be slipped at least over the exchanger body and can preferably be fixed to the two end pieces.

Depending on method variant, the material webs are already prefabricated in terms of their shape or are cut to size shortly before or during the winding.

Further embodiments and variants of the invention are laid down in the dependent claims.

### BRIEF DESCRIPTION OF THE DRAWINGS

Preferred embodiments of the invention are described in the following with reference to the drawings, which are for the purpose of illustrating the present preferred embodiments of the invention and not for the purpose of limiting the same. In the drawings,

FIG. 1 shows an exploded illustration of an exchanger device according to the invention without fans and motors;

FIG. 2 shows a perspective illustration of the exchanger device as per FIG. 1 in the assembled state;

FIG. 3 shows a perspective illustration of a part of the exchanger device as per FIG. 2;

FIG. 4 shows a partial section through the exchanger device as per FIG. 2;

FIG. 5 shows a perspective view of an end piece of the exchanger device as per FIG. 2 from a first end side;

FIG. 6 shows a perspective view of the end piece as per FIG. 5 from the opposite end side;

FIG. 7 shows a view of the end piece as per FIG. 5 from the first end side;

FIG. 8 shows a view of the end piece as per FIG. 5 from the opposite end side;

FIG. 9 shows a view of a material web of the exchanger device as per FIG. 1;

FIG. 10 shows a partial section through a part of the exchanger device as per FIG. 2, with a flow of a first fluid stream illustrated;

FIG. 11 shows a partial section through a part of the exchanger device as per FIG. 2, with a flow of a second fluid stream illustrated;

FIG. 12 shows a partial section through the exchanger device as per FIG. 2 with installed fans, according to a first embodiment;

FIG. 13 shows a longitudinal section through the device as per FIG. 12;

FIG. 14 shows a partial section through the exchanger device as per FIG. 2 with installed fans, according to a second embodiment;

FIG. 15 shows a longitudinal section through the device as per FIG. 14;

FIGS. 16a to 16f show different variants of windings of an exchanger body of the exchanger device as per FIG. 1;

FIGS. 17a to 17f show different variants of inlets and outlets of the end pieces of the exchanger device as per FIG. 1;

FIG. 18 shows an arrangement according to the invention for producing the exchanger device as per FIG. 2;

FIGS. 19a to 19f show cross sections through a first end piece of the exchanger device as per FIG. 1 at intervals along a longitudinal axis, and;

FIGS. 20a to 20f show cross sections through a second end piece of the exchanger device as per FIG. 1 at intervals along a longitudinal axis.

Identical parts are denoted by the same reference signs.

### DESCRIPTION OF PREFERRED EMBODIMENTS

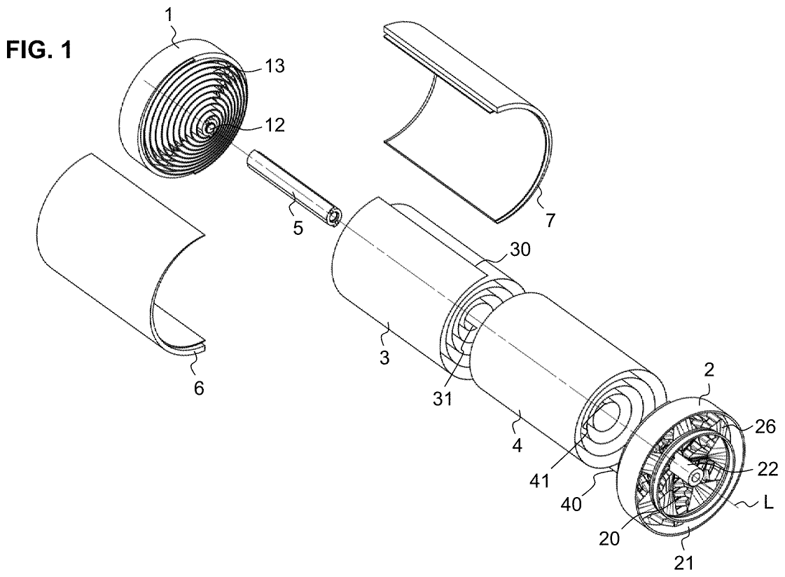

FIG. 1 illustrates a first embodiment of an exchanger device according to the invention, albeit without fans. The device illustrated here serves for use as a heat exchanger, preferably with moisture recovery. However, it may also be used in the same form as a mass-transfer device.

The device has a first end piece 1 and a second end piece 2 and an exchanger body 3, 4 which is arranged between said two end pieces 1, 2. The two end pieces 1, 2 are preferably manufactured from plastic or a metal and they are preferably of rigid form. Preferably, they have a round cross section. The exchanger body preferably has a double spiral, in this case in the form of two material webs 3, 4 which are wound up in a concentric manner around a rod 5. The material webs serve for heat transfer and preferably also exchange of moisture. They are manufactured from a material with good heat conductivity, for example from aluminum or an enthalpy-exchanger membrane. Other materials are known from the prior art and can likewise be used here. Layer materials can also be used. The two material webs 3, 4 are preferably self-supporting. In other embodiments, the two material webs 3, 4 are not self-supporting, but rather they are braced between the two end pieces 1, 2. The exchanger body is surrounded by a cover, in this case in the form of a semicylindrical first and second cover part 6, 7. The cover is preferably of rigid form.

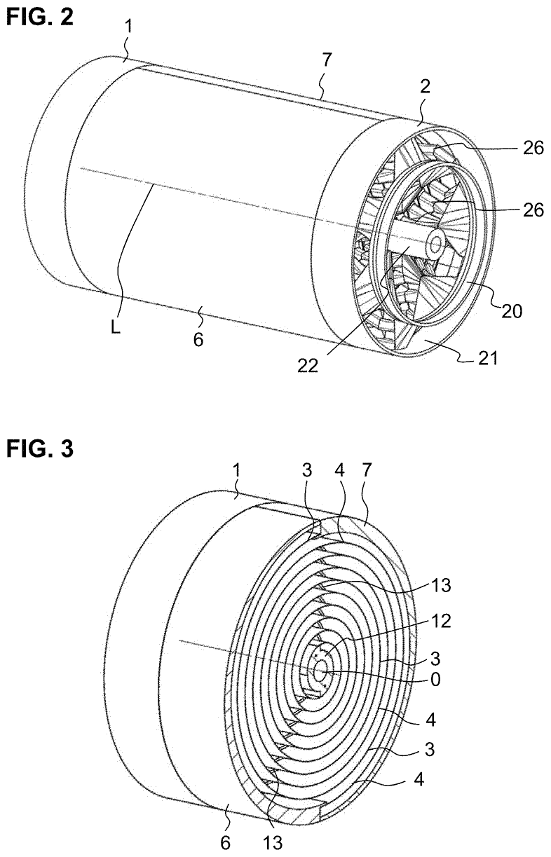

As can be seen in FIG. 2, in the assembled state, the device according to the invention forms a circular cylinder, preferably having an outer diameter which remains the same over its longitudinal axis L. The two material webs 3, 4 are wound up concentrically in such a way that they form a common double spiral.

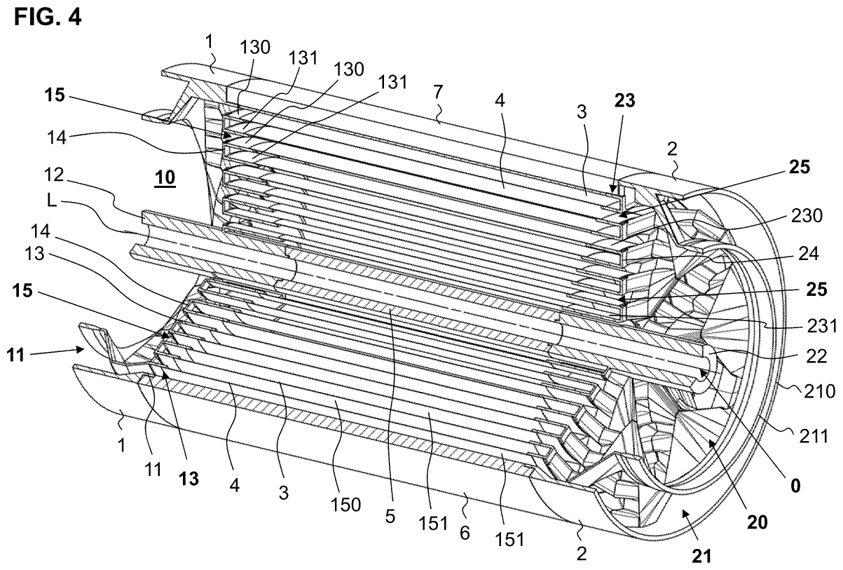

As can be seen in FIG. 1, on its end side facing toward the exchanger body, the first end piece 1 likewise forms a double spiral 13. The same applies to the second end piece 2, whose corresponding end side cannot be seen in FIG. 1, but is illustrated for example in FIG. 4.

FIG. 3 shows how the material webs 3, 4 are wound in a manner matching the double spiral 13 of the first end piece 1. They are accordingly also wound in a manner matching the identical double spiral 23 of the second end piece 2.

The longitudinal section as per FIG. 4 shows that the first material web 3 bears on first spiral ribs 130 of the double spiral 13 and the second material web 4 bears on second spiral ribs 131 of the double spiral 13. Preferably, said webs are adhesively bonded or welded to the ribs 130, 131 or are fastened thereto in some other manner. The same applies to the opposite end side of the material webs 3, 4 with regard to the second end piece 2. This, too, has first and second spiral ribs 230, 231 of the second spiral web 23.

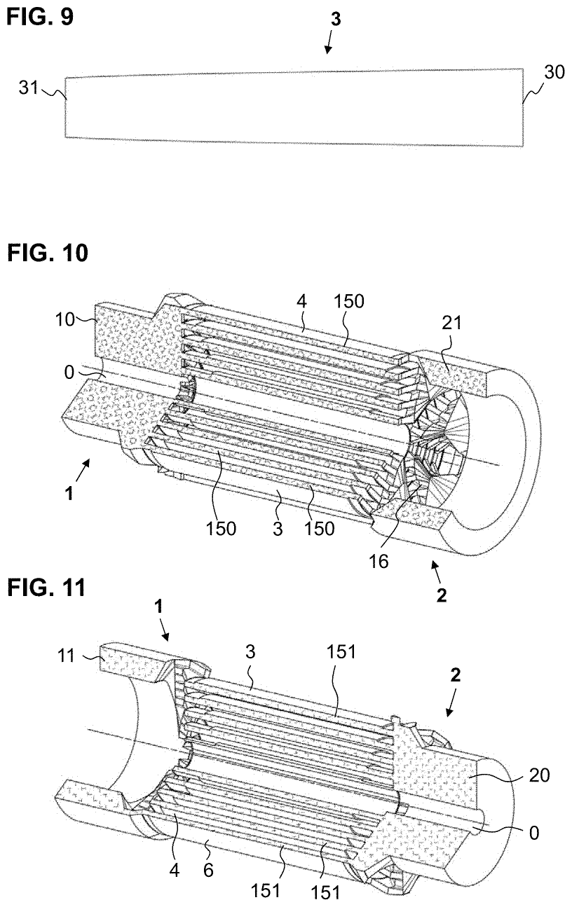

The spiral ribs 130, 131 and 230, 231 are formed to have different lengths. They are longer toward the longitudinal axis L such that the double spirals 13, 23 of the two end pieces in each case form a conical structure which projects at an end side and is directed toward the exchanger body. The material webs 3, 4 are correspondingly not of rectangular form, but of trapezoidal form, as can be seen in FIG. 9 with the first material web 3. The second material web 4 is preferably of identical form. The narrower end 31 is fastened on the rod 5. The wider end 30 forms the outer termination of the spiral. The same applies to the second material web 4. This second web 4 also has a narrower end 41 and a wider end 40.

The walls of the material webs 3, 4 serve as separating walls for a first spiral-shaped channel 150 and a second spiral-shaped channel 151. Both channels 150, 151 extend over the entire length of the exchanger body and form the contact surface for heat exchange and possibly also the filter surface for mass transfer.

As can be seen in FIG. 4, provision is made at both end sides of access points 15, 25 into the channels 150, 151 and of end-side closures 14 of the channels 150, 151. The second end piece 2 also has corresponding closures 24.

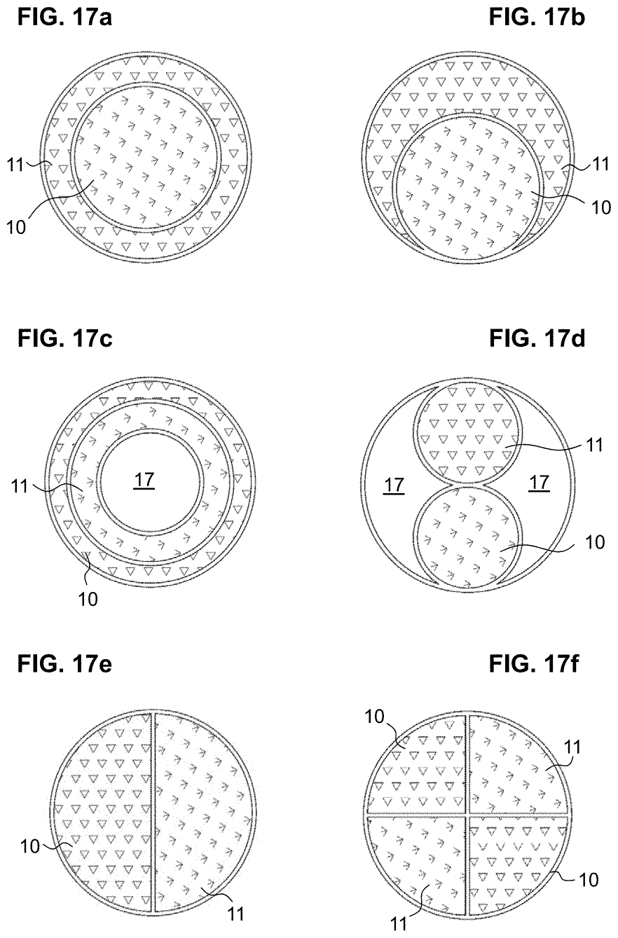

On their end sides which face away from the exchanger body and are directed outward, the two end pieces 1, 2 have inlets and outlets for throughflowing fluids. In the first end piece 1, a first inlet is denoted by the reference sign 10 and a first outlet is denoted by the reference sign 11. In the second end piece 2, a second inlet is denoted by the reference sign 20 and a second outlet is denoted by the reference sign 21. However, depending on use, the inlets and outlets may also be swapped around. If the exchanger device is operated not in a counterflow configuration but in a uniflow configuration, then one end piece has two inlets and the other end piece has two outlets. The terms are therefore to be understood in a correspondingly flexible manner in the description and in the patent claims, that is to say an inlet may also be an outlet depending on type of operation. In this example, the inlets and outlets are arranged concentrically with respect to one another. That is to say, the inner access point is circular and the outer access point surrounds this circle, which is concentric in relation to the longitudinal axis L, as a concentric circular ring. This is a preferred embodiment. Other embodiments are possible, however, as is illustrated in FIGS. 17a to 17f. These figures will be described in more detail in the text further below.

The two end pieces 1, 2 have a fluid-distribution structure 16, 26 between their inlet 10, 20 and outlet 11, 21 on one end side and the double spiral 13, 23 on the other end side. Said distribution structure 16, 26 serves for diverting a fluid, flowing in via the inlet 10, 20, into the associated double spiral 12, 23 in such a way that said fluid passes into the channel 150, 151 selected for the flow direction in this case. The distribution structure 16, 26 in the opposite end piece 1, 2 guides, from the channel 150, 151 into the outlet 11, 21 of said opposite end piece 1, 2, the fluid which has flowed through.

As can thus be clearly seen in FIG. 4, the fluids conducted in a counterflow configuration flow, separated by the walls of the material webs 3, 4, past one another without being mixed. The fluids flow in the exchanger body predominantly not along the spiral windings, but directly in the longitudinal direction L of the exchanger device.

FIG. 10 illustrates the flow of the first fluid through the first fluid channel 150, and FIG. 11 illustrates the flow of the second fluid through the second fluid channel 151. When viewed together, the two figures shows that the fluids are not mixed together, and that, owing to the double spiral of the exchanger body, they however impinge on a large common contact surface.

The longitudinal section as per FIG. 4 furthermore shows that the rod 5 adjoins a pin 12 of the first end piece 1 and a pin 22 of the second end piece 2. Preferably, said rod is connected to said pins, for example by means of a plug connection. The rod 5 and the two pins 12, 22 are preferably of hollow form and surround a passage opening O which extends over the entire length of the device.

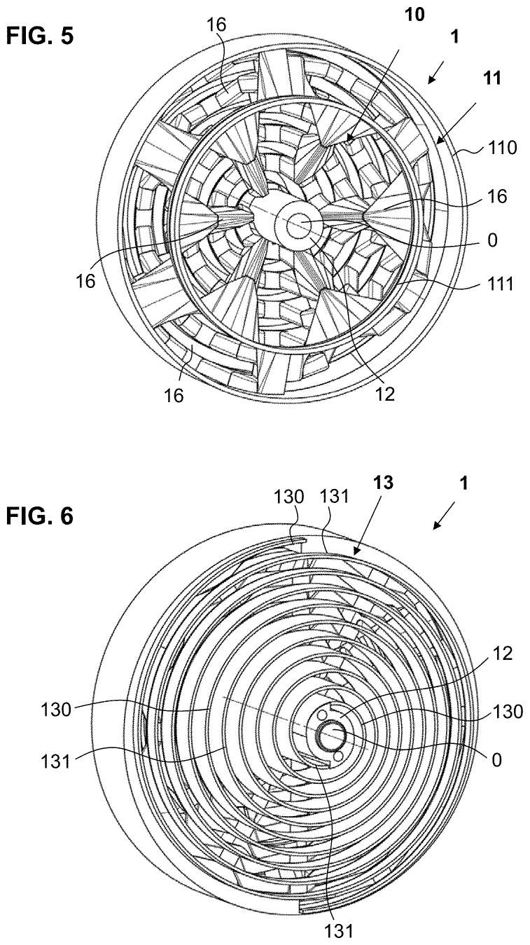

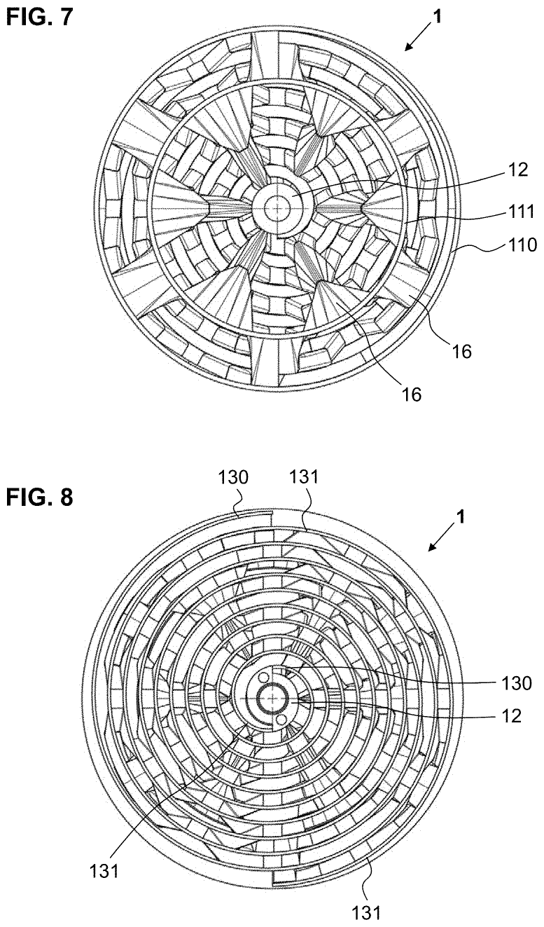

The two end sides of the first end piece 1 are illustrated in detail in FIGS. 5 to 8. The second end piece 2 is formed in an analogous or similar manner. The distribution structure 16 is not described in detail here. It is dependent on the arrangement of the inlets and outlets 10, 11, 20, 21 and on whether a double spiral, a triple spiral or some other type of multiple spiral is used. The shape of the spiral, too, influences the design of the distribution structure 16.

Said structure can however be calculated using conventional methods on the basis of these geometrical specifications.

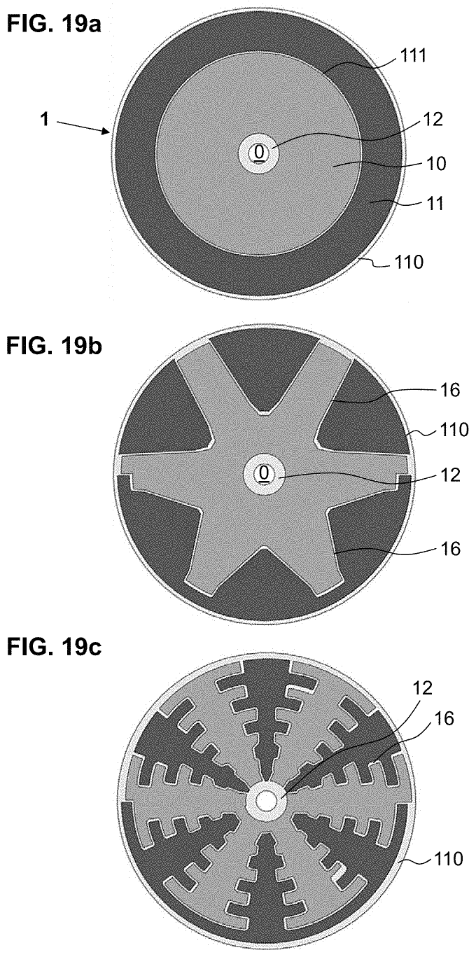

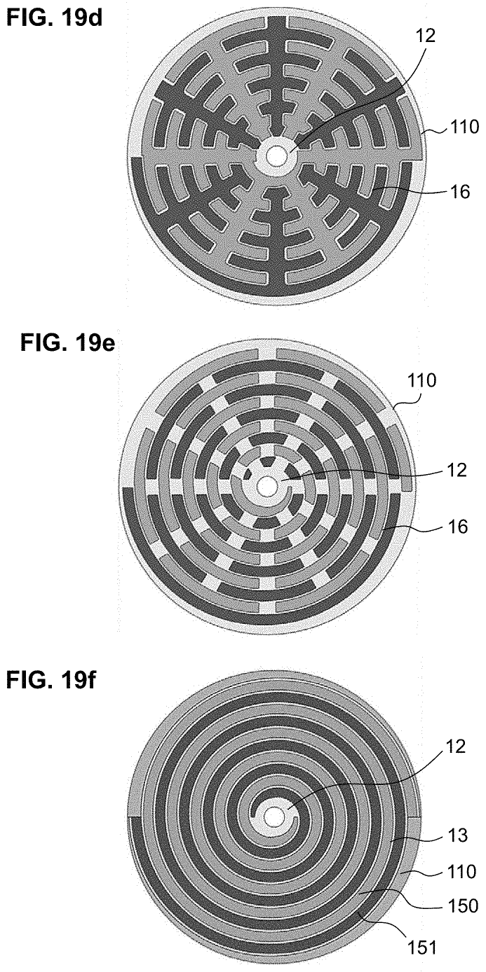

FIGS. 19a to 19f illustrate, for the first end piece 1, how the distribution structure 16 changes the two passages for the fluids from the first end side to the opposite end side. The two passages are illustrated in different gray shades.

In all of FIGS. 19a to 19f, the passage O through the pin 12 is unchanged. In FIG. 19a, the outer ring of the first end piece 1 is denoted by the reference sign 110. An inner ring 111 subdivides this first end side into the circular inlet 10 and the annular outlet 11. FIG. 19b illustrates a cross section through the distribution structure 16 at a first distance from the outer first end side. As can be seen, the distribution structure 16, beginning with the shape according to the inner ring 111, has changed to a star-shaped structure, which then subdivides the annular outlet into individual separated regions. A cross section as per FIG. 19c, taken at a larger distance from the outer first end side, shows a branching of the distribution structure 16 with the star-shaped subdivision remaining the same. The branching becomes greater as the distance from the outer end side increases, as is illustrated in FIG. 19d. As the second, opposite end side of the first end piece 1 is approached, ring-like or ring-segment-like structures, as shown in FIG. 19e, are formed, until, as per FIG. 19f, the double-spiral-shaped structure is obtained, which can be clearly seen for example in FIG. 6.

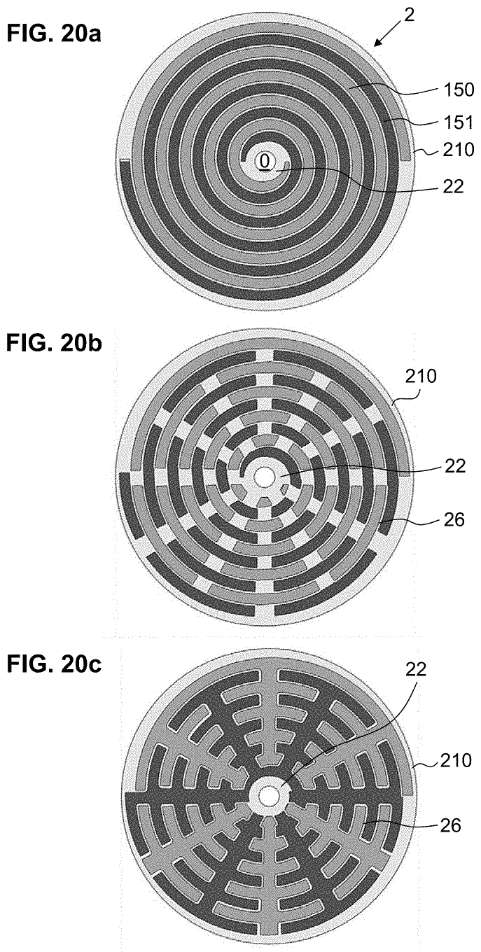

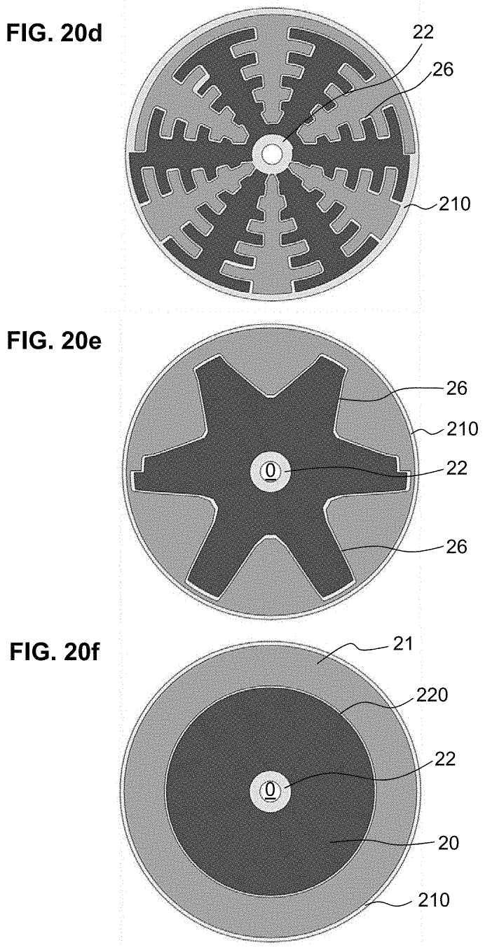

FIGS. 20a to 20f in turn show, now proceeding from that end side of the second end piece 2 which faces toward the exchanger body, the changing of the passages for the fluids with increasing distance from the end surface in this case. Comparison with FIGS. 19a to 19f shows that the distribution structure 26 of the second end piece 2 effects the same structural changes to the passages and consequently effects a transfer from the double spiral as per FIG. 20a to the concentrically arranged input and output 20, 21. During this transition from spiral-shaped channels to, for example, circular rings, the cross-sectional area per channel is preferably configured to be of approximately the same size at each location in the longitudinal direction, so as to counteract an increased pressure loss through flow constriction. Here, in this example, the fluid which has flowed into the device through the circular inlet 10 of the first end piece 1 now passes into the annular outlet 21 of the second end piece 2, and the fluid which flows through the circular inlet 20 of the second end piece 2 passes into the annular outlet 11 of the first end piece 1. This type of throughflow results in the same flow resistance and a uniform flow speed at all positions in the air channels for the two flow channels. At each position in the end piece,
cross-sectional area of the circular inlet 10=
cross-sectional area of the annular inlet 11=constant

(with equal volumetric flow rates and identical fluids)

preferably holds as an approximation.

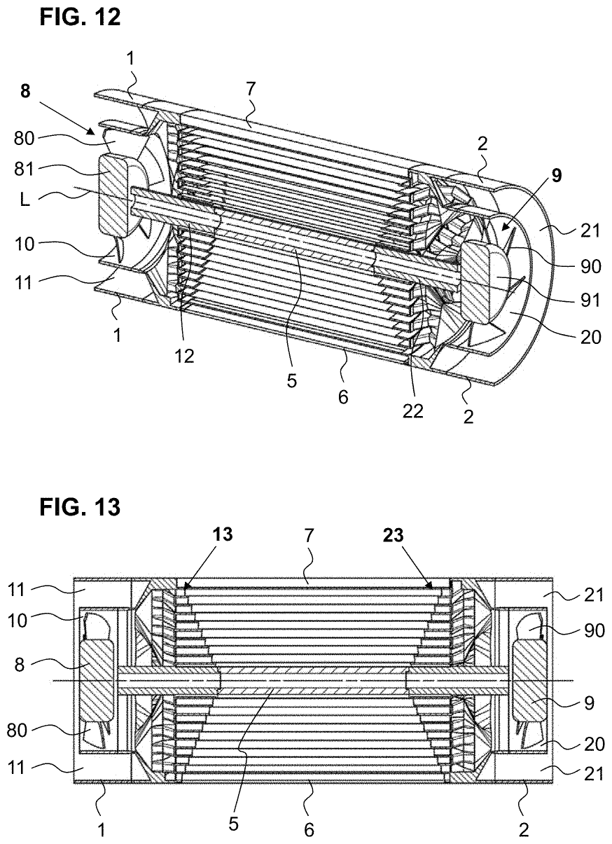

The previous figures have shown the device without fans. In the case of such exchanger devices, the fluids are however normally conveyed in an active manner, for example by way of at least one fan. FIGS. 12 and 13 therefore illustrate a first embodiment with two fans. A first fan 8, having fan blades 80 and a motor 81, is arranged concentrically in relation to the longitudinal axis L. A second fan 9, having fan blades 90 and a motor 91, is provided on the opposite side, likewise arranged concentrically in relation to the longitudinal axis L.

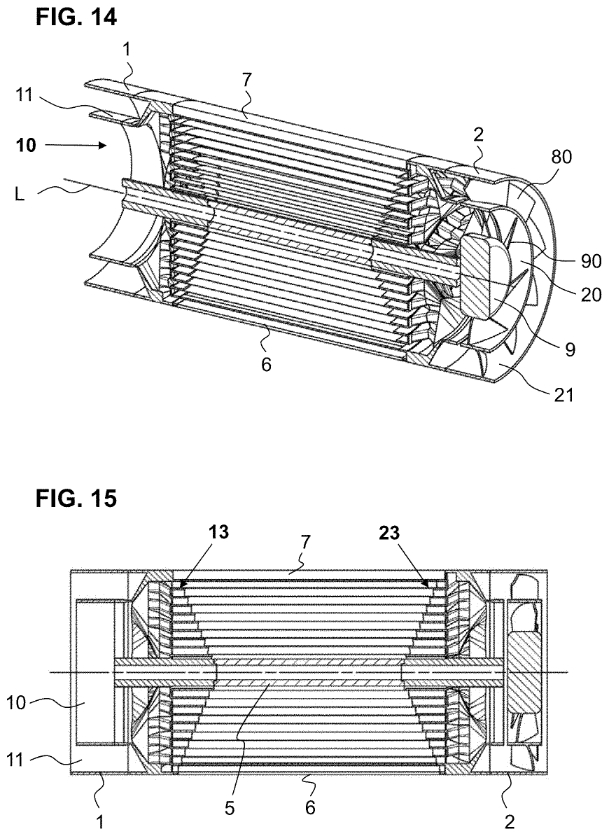

In the embodiment as per FIGS. 14 and 15, both fans 8, 9 are arranged on the same end side of the device, preferably likewise oriented concentrically in relation to the longitudinal axis L.

As already mentioned further above, the exchanger body can be formed as a double spiral or multiple spiral in different ways. In the above-described embodiments, the two material webs 3, 4 were wound to form a spiral with a circular cross section, preferably with equidistant spiral turns and thus with a channel width that remains the same.

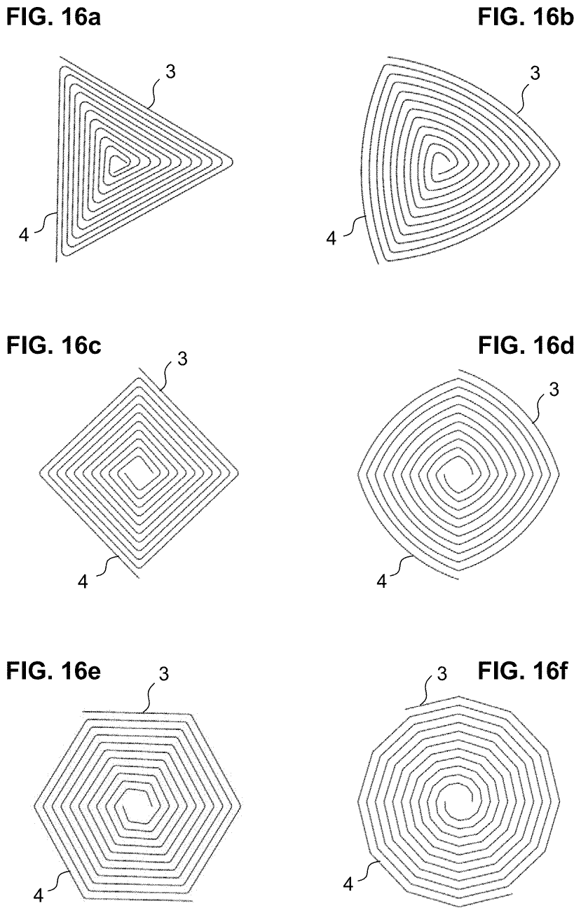

FIGS. 16a to 16f illustrate other embodiments of double spirals formed by the two material webs 3, 4. The double spirals of the two end pieces 1, 2 are formed analogously in order that a sealed connection and the formation of the desired separated channels 150, 151 can in turn take place. In FIG. 16a, the cross section is a triangle, preferably an equilateral triangle. The edges are preferably bent. In FIG. 16b, the sides of the triangle are bent outward, the edges preferably being sharp for this purpose. The shape of the edges is not however related to the type and/or shape of the sides. The edge radius is preferably the same in the two embodiments as per FIGS. 16a and 16b and is not related to the bent surface. The bent surface has the advantage that the individual surfaces have less of a tendency to crumple and/or warp and a slightly larger exchanger surface area can thus also be realized.

FIGS. 16c and 16d shows the same variations for a rectangular, preferably square, cross section.

FIG. 16e shows a winding forming a hexagonal cross section, and FIG. 16f shows one forming a dodecagonal cross section. Other, even asymmetric, shapes may likewise be used.

Preferably, spacers are provided in order for the material webs to be kept at a desired distance from one another. This is intended to ensure that the channel cross sections do not vary to too great an extent. In particular in the case of structurally non-self-supporting membranes with insufficient stiffness, such precautionary measures are advisable, since they could for example alter their distance from one another depending on the flow conditions.

These spacers are for example webs introduced between the material webs 3, 4 along the longitudinal axis L of the exchanger device. Owing to the arrangement of the webs in the longitudinal direction, the fluid flow is not impeded, or is impeded only to an insignificant extent, since the fluid flow is likewise realized in the longitudinal direction L.

Preferably, the webs are always positioned at the same position and are thus, as seen in cross section, “stacked one on top of the other”, or they are arranged in a manner extending radially away from the center. In the case of a polygonal cross section, the webs are preferably situated at the corners of the polygons.

Owing to the webs, forces that occur can be accommodated more effectively.

The webs preferably extend approximately over the entire length of the exchanger body. They are continuous or provided with interruptions. In other embodiments, instead of webs, spacers are attached at points. Said spacers are for example studs distributed over the material webs. The studs, too, preferably extend radially outward in order, in this way, for forces that occur to be accommodated inwardly as far as the rod 5 at the same position.

The spacers, depending on embodiment, are, prior to the winding of the material webs 3, 4, already mounted on the webs or are an integral constituent part of the webs. In other embodiments, the spacers are placed between the material webs 3, 4 during the winding.

As likewise mentioned above, it is also possible for the inlets and outlets 10, 11, 20, 21 of the two end pieces 1, 2 to be of a different configuration. FIG. 17a shows the already shown concentric circular arrangement of the inlet 10 and the outlet 11. In FIG. 17b, the inner circular inlet 10 is arranged eccentrically. In FIG. 17c, the inlet and the outlet 10, 11 are of annular form, but preferably formed concentrically with respect to one another and concentrically with respect to the longitudinal axis L. Situated at the center is a clearance 17 which may be formed to be closed or open at the end side. In FIG. 17d, both the inlet 10 and the outlet 11 are circular, so that a clearance 17 is then present on both sides. FIG. 17e shows a semicircular formation of the inlet and the outlet 10, 11. In FIG. 17f, the end side is subdivided into four or more sectors, and two or more inlets 10 and two or more outlets 11 are present. The same arrangements may also be used in the second end piece 2.

The various embodiments of the end pieces 1, 2 can be combined with one another in any desired manner. Also, any embodiments of double spirals or multiple spirals of the exchanger body can be combined with any embodiments of the end pieces 1, 2. The embodiment of the flow distribution means in the end pieces is adapted accordingly.

In preferred embodiments, the flow resistance through the passage opening 0, formed by the rod 5 and the two pins 12, 22, corresponds to the flow resistance through the channels 150, 151. The inner diameter of the passage opening 0, that is to say the clear width thereof, is correspondingly selected for this purpose.

The passage opening forms a bypass, preferably in the form of a central channel. Owing to said bypass, the exchanger device can be operated without exchange of heat and/or moisture. This can be achieved in that a first volume stream of a first fluid is conducted through one of the channels 150, 151 and a second volume stream of a second fluid is conducted through the passage opening 0. The first and the second fluid may for example both be air or water.

The conveyance of the second volume stream through the passage opening 0 is preferably realized by means of a third fan. Alternatively, the already described first or second fan can be used, wherein said first or second fan acts alternately or selectively on the central channel and one of the two mentioned channels 150, 151. Preferably, this alternating or selective use is realized by means of a switching device which diverts the volume stream into the desired channel.

A further advantage of this internal bypass or the passage opening 0 is that the manufacturing of the exchanger device is simplified. Owing to the increased outer diameter of the rod 5, the material webs 3, 4 can be wound up more easily. Moreover, the hollow rod 5 of the exchanger device provides improved structural properties.

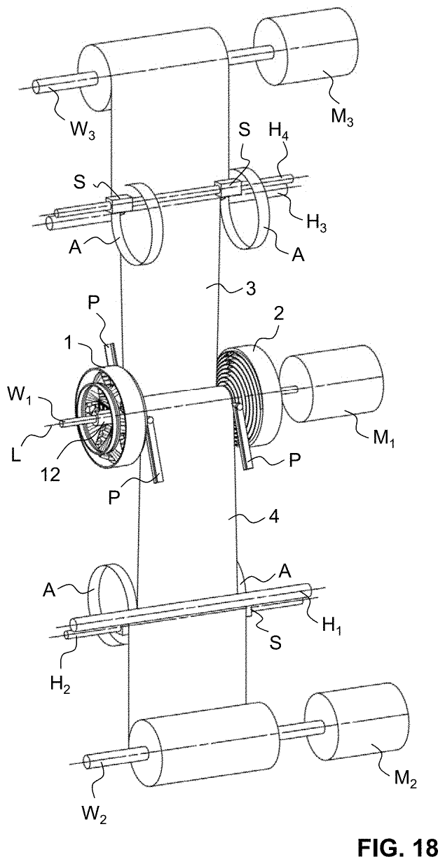

As already mentioned, the exchanger device according to the invention can be produced in different ways. It may be produced for example in one piece or multiple pieces in a 3D printing process or at least partially in an injection-molding process. On the basis of FIG. 18, however, a description will be given of a method according to the invention which permits simple and inexpensive production.

The two end pieces 1, 2 are of one-part or multiple-part form, and are produced and made available as separate components. They are preferably manufactured in a 3D printing process, in an injection-molding process or by some other suitable type of production.

For the assembly of the exchanger device, the two end pieces 1, 2 are pushed onto a common first shaft W₁ at a predefined distance from one another, wherein the rod 5 is arranged between them. The passage opening O already described serves for this purpose. The shaft W₁ can be driven by means of a first motor M₁. A second and a third shaft W₂, W₃ are present on two opposite sides of the first shaft W₁, in this case above and below the first shaft W₁, and are likewise preferably driven by means of a second and a third motor M₂, M₃. A controller (not illustrated here) controls and coordinates the movement of the three motors M₁, M₂, M₃. Arranged on the second shaft W₂ is a roller with the second material web 4, and arranged on the first shaft W₁ is a roller with the first material web 3.

Arranged between the adjacent shafts W₁, W₂, W₃ are preferably first and second guide rollers H₁, H₂ and third and fourth guide rollers H₃, H₄ as well as cutting elements S. The guide rollers H₁, H₂, H₃, H₄ guide the material webs 3, 4 during the winding. The cutting elements S, for example blades, cut the fed straight material webs into the desired conical shape. The material pieces cut away are denoted by the reference sign A in FIG. 18.

Welding mandrels P in the region of the end pieces 1, 2 serve for fixing the end-side ends of the material webs 3, 4 to the spiral ribs 130, 131, 230, 231 of the end pieces 1, 2.

At the beginning of the process, the narrow ends 31, 41 of the two material webs 3, 4 are preferably fastened to the rod 5. Subsequently, the first motor M₁ and possibly also the two other motors M₂, M₃ are activated, and the material webs 3, 4 are wound in the desired shape around the rod 5. Here, the spiral ribs 130, 131, 230, 231 of the end pieces 1, 2 predefine the desired shape and distance of the individual spiral windings from one another. If the desired double spiral is obtained, then preferably a cover for protecting the exchanger body can also be attached. By means of the same method, it is also possible for more than two material webs to be wound simultaneously to form a multiple spiral.

The device according to the invention makes it possible to design exchanger devices with high efficiency and yet with a small outer diameter. Moreover, the production is facilitated.

LIST OF REFERENCE SIGNS

| | | | |
|---|---|---|---|
| 1 | First end piece | 41 | Narrower end |
| 10 | First inlet | | |
| 11 | First outlet | 5 | Rod |
| 110 | Outer ring | | |
| 111 | Inner ring | 6 | First cover part |
| 12 | Pin | | |
| 13 | Double spiral | 7 | Second cover part |
| 130 | First spiral ribs | | |
| 131 | Second spiral ribs | 8 | First fan |
| 14 | Closure | 80 | First fan blades |
| 15 | Access point | 81 | First motor |
| 150 | First channel | | |
| 151 | Second channel | 9 | Second fan |
| 16 | Distribution structure | 90 | Second fan blades |
| 17 | Clearance | 91 | Second motor |
| 2 | Second end piece | A | Cut-away material |
| 20 | Second inlet | L | Longitudinal axis |
| 21 | Second outlet | H₁ | First guide roller |
| 22 | Pin | H₂ | Second guide roller |
| 23 | Double spiral | H₃ | Third guide roller |
| 230 | First spiral ribs | H₄ | Fourth guide roller |
| 231 | Second spiral ribs | M₁ | First motor |
| 24 | Closure | M₂ | Second motor |
| 25 | Access point | M₃ | Third motor |
| 26 | Distribution structure | O | Passage opening |
| | | P | Welding mandrel |
| 3 | First material web | S | Cutting element |
| 30 | Wider end | W₁ | First shaft |
| 31 | Narrower end | W₂ | Second shaft |
| | | W₃ | Third shaft |
| 4 | Second material web | | |
| 40 | Wider end | | |

1. A exchanger device having a first end piece, having a second end piece, and having an exchanger body arranged therebetween, wherein the first end piece has a first end side with a first inlet and with a first outlet, and the second end piece has a second end side with a second inlet and with a second outlet, wherein the first and second end sides face away from the exchanger body, and wherein the exchanger body has at least one first channel which connects the first inlet of the first end piece to the second outlet of the second end piece, and wherein the exchanger body has at least one second channel which connects the second inlet of the second end piece to the first outlet of the first end piece, wherein the exchanger body forms a multiple spiral, in particular a double spiral, or multiple concentric ring surfaces, and the windings of the multiple spiral or of the concentric ring surfaces form separating walls between the at least one first and the at least one second channel.

2. The exchanger device as claimed in claim 1, wherein the first end piece is configured as a fluid distributor and has a distribution structure for diverting a first fluid from the first inlet into the at least one first channel of the exchanger body.

3. The exchanger device as claimed in claim 1, wherein the first end piece is configured as a fluid distributor and has a distribution structure for diverting a first fluid from the first inlet into the at least one first channel of the exchanger body.

4. The exchanger device as claimed in claim 1, wherein the second end piece is configured as a fluid distributor and has a distribution structure for diverting a second fluid from the second inlet into the at least one second channel of the exchanger body.

5. The exchanger device as claimed in claim 1, wherein the first end piece has a third end side, which is situated opposite the first end side, and wherein the distribution structure forms a multiple spiral, in particular a double spiral, or multiple concentric ring surfaces on the third end side, and wherein the second end piece has a fourth end side, which is situated opposite the second end side, and wherein the distribution structure forms a multiple spiral, in particular a double spiral, or multiple concentric ring surfaces on the fourth end side.

6. The exchanger device as claimed in claim 5, wherein the multiple spiral formed in the first and/or in the second end piece projects outward toward its center, or the concentric ring surfaces project outward toward their center.

7. The exchanger device as claimed in claim 6, wherein the multiple spiral formed in the first and in the second end piece or the concentric ring surfaces are/is in the form of a cone and project(s) outward.

8. The exchanger device as claimed in claim 1, wherein the multiple spiral of the exchanger body is formed by at least two material webs which are wound up together.

9. The exchanger device as claimed in claim 1, wherein the multiple spiral or the concentric ring surfaces of the exchanger body has/have a round, triangular, quadrangular, square, hexagonal, octagonal or dodecagonal cross section.

10. The exchanger device as claimed in claim 1, wherein the multiple spiral or the concentric ring surfaces of the exchanger body have windings which are curved or sectionally rectilinear.

11. The exchanger device as claimed in claim 1, the exchanger body having an exchange/transfer surface for exchange of heat and/or transfer or mass, and the exchanger device having a passage opening which extends from the first end piece to the second end piece through the exchanger body and which runs separately from the exchange/transfer surface.

12. The exchanger device as claimed in claim 1, wherein spacers are arranged between two adjacent separating walls.

13. The exchanger device as claimed in claim 1, wherein the multiple spiral or the concentric ring surfaces of the exchanger body is/are formed from at least one enthalpy-exchanger membrane, for the purpose of recovering heat and air moisture.

14. The exchanger device as claimed in claim 1, wherein the first and the second end piece are formed as separate components, and can be connected to the exchanger body during the assembly of the device.

15. The exchanger device as claimed in claim 1, wherein the device is a heat exchanger and/or a mass-transfer device.

16. A method for producing an exchanger device as claimed in claim 1, wherein the first end piece and the second end piece are arranged at a defined distance from one another, wherein, for forming the multiple spiral of the exchanger body, at least one first material web, from a first side, and at least one second material web, from a second side, are wound up together, and wherein the two end-side ends of the wound-up material webs are connected to the first and/or to the second end piece during or after the winding.

17. The exchanger device as claimed in claim 1, wherein the first end piece has a third end side, which is situated opposite the first end side, and wherein the distribution structure forms a multiple spiral, in particular a double spiral, or multiple concentric ring surfaces on the third end side, or wherein the second end piece has a fourth end side, which is situated opposite the second end side, and wherein the distribution structure forms a multiple spiral, in particular a double spiral, or multiple concentric ring surfaces on the fourth end side.

18. The exchanger device as claimed in claim 17, wherein the multiple spiral formed in the first or in the second end piece projects outward toward its center, or the concentric ring surfaces project outward toward their center.

19. The exchanger device as claimed in claim 18, wherein the multiple spiral formed in the first or in the second end piece or the concentric ring surfaces are/is in the form of a cone and project(s) outward.
